(19) United States
(12) Patent Application Publication
(10) Pub. No.: US 2010/0246633 A1
(43) Pub. Date: Sep. 30, 2010

(54) TESTING APPARATUS FOR COMPUTER MOTHERBOARD DESIGN

(75) Inventors: XIAO-ZHU CHEN, Shenzhen City (CN); ZHEN-XING YE, Shenzhen City (CN); CHIA-SHIN CHOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD, Shenzhen City (CN); HON HAI PRECISION INDUSTRY CO., LTD., Tu-Cheng (TW)

(21) Appl. No.: 12/430,063

(22) Filed: Apr. 24, 2009

(30) Foreign Application Priority Data
Mar. 24, 2009 (CN) 200910301082.2

(51) Int. Cl. G01D 21/00

(52) U.S. Cl. 374/210

(57) ABSTRACT

A testing apparatus for a motherboard design includes a plurality of electrical elements. The testing apparatus includes a body, a plurality of heat source modules, and a power source terminal. The plurality of heat source modules is positioned on the body and produce heat to simulate the electrical elements of the motherboard. The power source terminal is connected to the plurality of heat source modules via cables and connected to a power supply. When the power supply is turned on, the power supply provides working voltages to the heat source modules to signal the heating source modules to simulate the heat production of the electrical elements of the motherboard design.

### BACKGROUND

1. Technical Field

The present disclosure relates to testing apparatuses, and particularly, to a testing apparatus for a computer motherboard design.

2. Description of Related Art

Thermal characteristic is one of the most important factors affecting reliability and stability of computer systems. Therefore, before manufacturing the computer systems, designers need to perform thermal characteristic tests on their designs. However, usually designers can only do the tests by directly testing on samples of computer systems. However, manufacturing samples of the computer systems is costly and time consuming.

### BRIEF DESCRIPTION OF THE DRAWINGS

FIG. 1 is a schematic diagram of an embodiment of a testing apparatus for a computer motherboard.

FIG. 2 is a schematic diagram of the testing apparatus of FIG. 1 connected to ceramic aluminum heat dissipating members.

### DETAILED DESCRIPTION

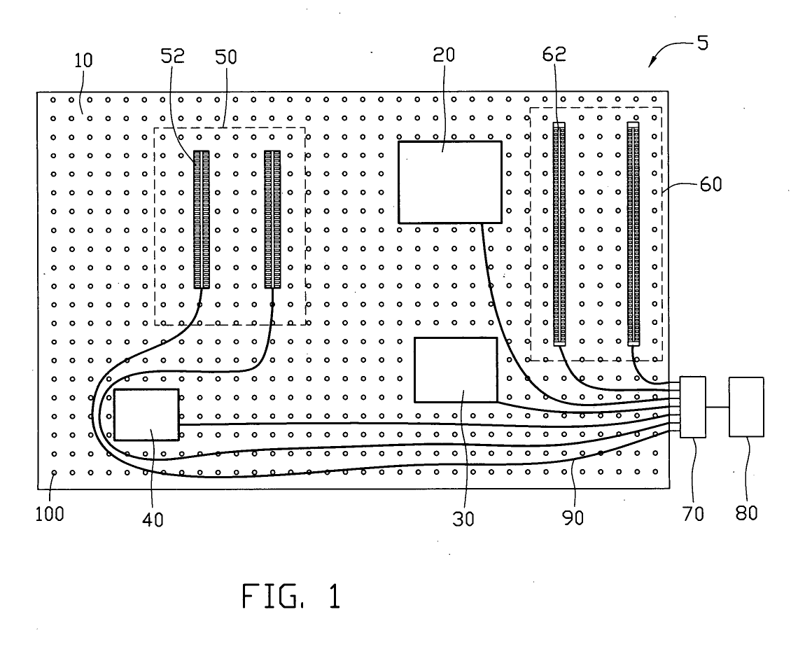

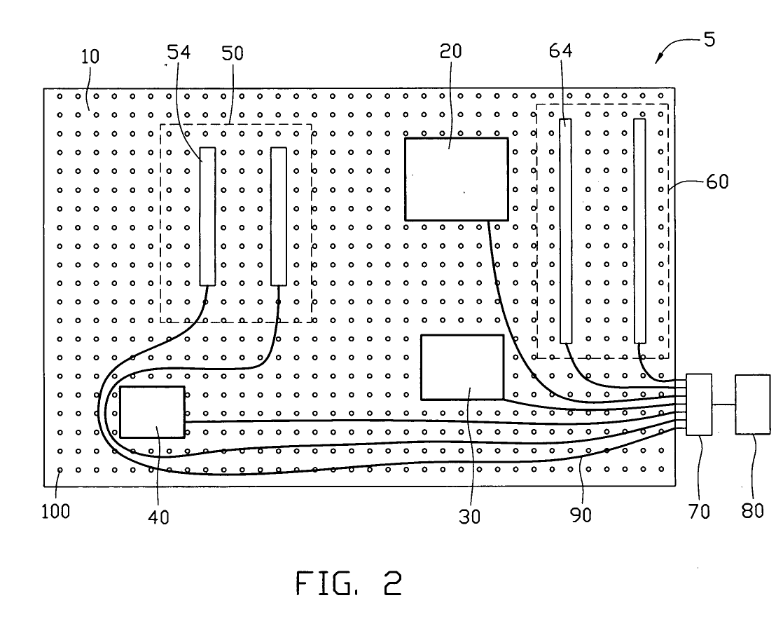

Referring to FIGS. 1 and 2, an exemplary embodiment of a testing apparatus 5 for a computer motherboard design includes a body 10, and a plurality of heat source modules each capable of being selectively mounted to different positions on the body 10, to simulate a motherboard design to be tested. In one embodiment, the plurality of heat source modules may be selected from the group consisting of a processor module 20, a north bridge module 30, a south bridge module 40, a peripheral component interconnect (PCI) module 50, a memory module 60, and a power terminal 70. The body 10 defines a plurality of holes 100 for fixing the processor module 20, the north bridge module 30, the south bridge module 40, the PCI module 50, and the memory module 60 on the body 10. Positions of the processor module 20, the north bridge module 30, the south bridge module 40, the PCI module 50, and the memory module 60 on the body 10 are arranged according to the motherboard design being tested.

The processor module 20, the north bridge module 30, the south bridge module 40, the PCI module 50, and the memory module 60 are respectively connected to the power terminal 70 via cables 90. The power terminal 70 is configured to be connected to a power supply 80. The power supply 80 provides working voltages for the processor module 20, the north bridge module 30, the south bridge module 40, the PCI module 50, and the memory module 60 via the power terminal 70.

In one embodiment, the power supply 80 is a 12V power supply as would be used for providing voltage to a host computer. The body 10 is a printed circuit board (PCB). The plurality of holes 100 of the body 10 can be replaced by other mounting structures for mounting the modules on the body 10. The numbers of the processor module 20, the north bridge module 30, the south bridge module 40, the PCI module 50, and the memory module 60 can be selected according to need.

In one embodiment, the processor module 20, the north bridge module 30, and the south bridge module 40 are ceramic aluminum heat dissipating members, and respectively configured to simulate the heat production of a CPU, a north bridge chip, and a south bridge chip of a computer motherboard design. The PCI module 50 includes a plurality of PCI sockets 52 and a plurality of ceramic aluminum heat dissipating members 54. The plurality of ceramic aluminum heat dissipating members 54 is configured to simulate PCI devices of the computer motherboard. The plurality of PCI sockets 52 is mounted on the body 10 via some corresponding holes 100. Each of the plurality of ceramic aluminum heat dissipating members 54 of the PCI module 50 is connected to a corresponding PCI socket 52. The plurality of PCI sockets 52 is respectively connected to the power terminal 70. The memory module 60 includes a plurality of memory sockets 62 and a plurality of ceramic aluminum heat dissipating members 64. The plurality of ceramic aluminum heat dissipating members 64 of the memory module 60 is configured to simulate memory devices of a computer motherboard. The plurality of memory sockets 62 is mounted on the body 10 via some corresponding holes 100. Each of the plurality of ceramic aluminum heat dissipating members 64 of the memory module 60 is connected to a corresponding memory socket 62. The plurality of memory sockets 62 is respectively connected to the power terminal 70. For example, when the power of the CPU is 120 W, the power of the ceramic aluminum heat dissipating member of the processor module 20 is also 120 W. When the power of north bridge chip is 30W, the power of the ceramic aluminum heat dissipating member of the north bridge module 30 is also 30 W. When the power of south bridge chip is 10 W, the power of the ceramic aluminum heat dissipating member of the south bridge module 40 is also 10 W.

In testing, the needed heat source modules are selected, such as the processor module 20, the north bridge module 30, the south bridge module 40, the PCI module 50, and the memory module 60, and mounted to the body 10 and connected to the power terminal 70 via the cables 90 according to the computer motherboard design to be tested. Then the power terminal 70 is connected to the power supply 80. When the power supply 80 is turned on, the power supply 80 provides working voltages to the processor module 20, the north bridge module 30, the south bridge module 40, the PCI module 50, and the memory module 60 for simulating the working states of the CPU, the north bridge chip, the south bridge chip, the PCI devices, and the memory devices of the computer motherboard design being tested.

A heat dissipation plan can be obtained according to positions of the modules being arranged on the body 10. If the heat dissipation plan can satisfy a heat dissipation requirement of a computer motherboard, electrical elements of the computer motherboard can be arranged according to the simulation states corresponding to the heat dissipation plan. If the heat dissipation plan can not satisfy the heat dissipation requirement of the computer motherboard, the positions of the modules must be changed in order to satisfy the heat dissipation requirement.

The testing apparatus can simulate the heat states of the electrical elements of the computer motherboard through the body 10, the plurality of PCI sockets, the plurality of memory socket, and the plurality of ceramic aluminum heat dissipating members. The testing apparatus can replace a sample of the computer motherboard for performing thermal characteristic tests. The testing apparatus is time saving and low cost.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A testing apparatus for a motherboard design comprising a plurality of electrical elements, the testing apparatus comprising:
a body;
a plurality of heat source modules positioned and arranged on the body according to the plurality of electrical elements, the plurality of heat source modules operable to produce heat to simulate the electrical elements of the motherboard; and
a power source terminal connected to the plurality of heat source modules via cables and connected to a power supply, wherein the power supply is turned on to provide working voltages to the heat source modules to signal the plurality of heat source modules to simulate the heat production of the electrical elements of the motherboard design.

2. The testing apparatus of claim 1, wherein the plurality of heat source modules is selected from the group consisting of a processor module, a north bridge module, a south bridge module, a peripheral component interconnection (PCI) module, and a memory.

3. The testing apparatus of claim 2, wherein the processor module, the north bridge module, and the south bridge module are ceramic aluminum heat dissipating members; the PCI module comprises a plurality of PCI sockets and a plurality of ceramic aluminum heat dissipating members, the plurality of PCI sockets is mounted on the body, each of the plurality of ceramic aluminum heat dissipating members of the PCI module is connected to a corresponding PCI socket; the memory module comprises a plurality of memory sockets and a plurality of ceramic aluminum heat dissipating members, the plurality of memory sockets is mounted on the body, each of the plurality of ceramic aluminum heat dissipating members of the memory module is connected to a corresponding memory socket.

4. The testing apparatus of claim 1, wherein the body is a printed circuit board.

5. The testing apparatus of claim 1, wherein the body defines a plurality of holes, the plurality of heat source modules being positioned on the body via the holes.
